(19) United States
(12) Patent Application Publication
(10) Pub. No.: US 2026/0244443 A1
(43) Pub. Date: Aug. 20, 2026

(54) PREDICTIVE STORE-TO-LOAD FORWARDING

(71) Applicant: Google LLC, Mountain View, CA (US)

(72) Inventors: Vineeth Thamarassery Mekkat, San Ramon, CA (US); Leigang Kou, Austin, TX (US)

(21) Appl. No.: 19/162,251

(22) PCT Filed: Mar. 8, 2023
(86) PCT No.: PCT/US2023/014815

§ 371 Date: Sep. 4, 2025

(51) Int. Cl. G06F 9/30

(52) U.S. Cl. CPC G06F 9/30043

(57) ABSTRACT

A method for performing predictive store-to-load forwarding on a processor includes receiving a load instruction, performing a predictive store-to-load forwarding process including obtaining, from a prediction table, a predicted store queue id based on an address of the load instruction, looking up a value from a store queue based on the store queue id while performing a parallel verification process for the predicted store queue id, determining that the parallel verification process succeeded, and in response, reading the value for the load instruction from the store queue.

### BACKGROUND

In modern computing, loading from memory and storing to memory are performance critical operations in a program. Many modern computers support store-to-load forwarding (STLF) that allows data to be forwarded, within a processing pipeline, from a store instruction to a load instruction rather than writing the data out to memory with the store instruction and reading the same data back in with the load instruction.

To support STLF, a processor can maintain a store queue (SQ) that keeps track of all the stores that are pending. When a subsequent load instruction is executed, the processor can check the store queue to determine whether the data to be loaded is in the processor's internal store queue, in which case store-to-load forwarding can occur by retrieving the data from the internal store queue rather than from memory. However, as modern execution windows increase, the size of the store queue also increases. Modern processor can for example have hundreds of pending store instructions in a store queue. Thus, reading the entirety of a large store queue for STLF can actually hurt performance

### SUMMARY

This specification describes methods and systems to provide predictive store-to-load forwarding, which can significantly improve the overhead of STLF on large store queues and execution windows. For example, a large store queue can block instruction execution. A prediction method as disclosed herein can achieve efficient STLF on a large store queue, e.g., by predicting the location of a store instruction in the store queue rather than searching through the entire store queue.

Particular embodiments of the subject matter described in this specification can be implemented so as to realize one or more of the following advantages.

The described methods and systems improve the performance of central processing units (CPUs) with large store queues, e.g., large numbers of instructions, which would typically create challenges for efficient STLF. For example, the described methods and systems allow for more efficiently performing STLF even with very large store queues, e.g., store queues having 100 or 1000 entries, that would traditionally reduce the efficiency of STLF. In some implementations, the methods and systems can increase the performance of a CPU by about 1-2%.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a diagram of an example execution window containing instructions

FIG. 1B is a diagram of execution stages of an STLF process on the instructions.

FIG. 2 is a diagram of execution stages of a predictive STLF process.

FIG. 3 is an example table that can be used for a predictive STLF process.

FIG. 4 is a flowchart illustrating a method of a predictive STLF process.

FIG. 5 is an example computational environment that can perform a predictive STLF process.

Like reference numbers and designations in the various drawings indicate like elements.

### DETAILED DESCRIPTION

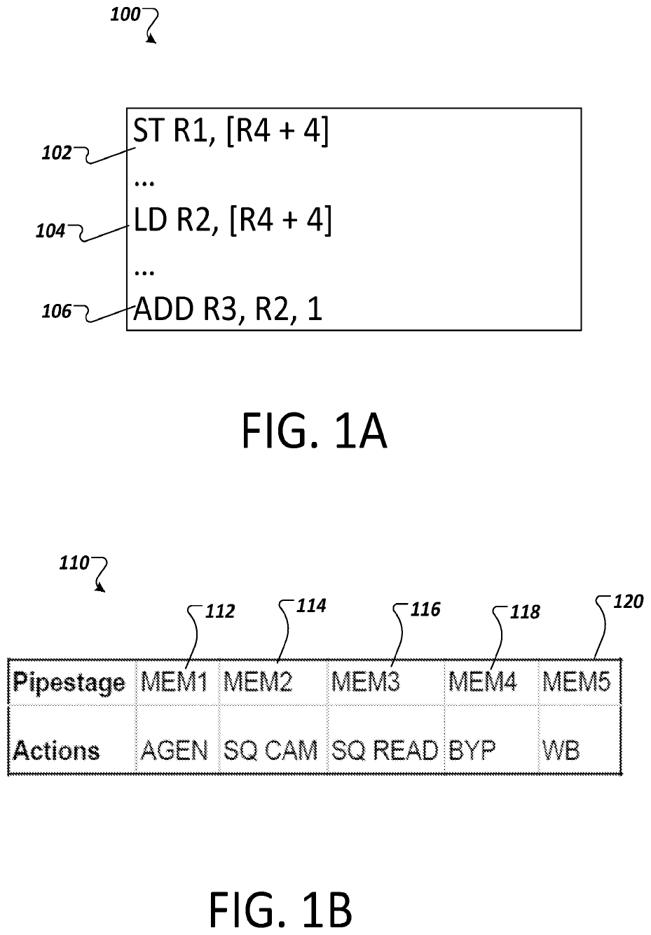

FIG. 1 is a diagram of an example execution window 100 containing instructions and execution stages of an STLF process on the instructions. For example, the execution window 100 includes a store instruction 102 that writes data in register R1 into a location in memory, e.g., as given by an address. In the illustrated example, the store instruction 102 is writing data into the memory location given by an address value in the register R4 plus a 4-byte offset (R4+4).

The execution window 100 also includes a load instruction 104 that reads, into a register R2, data from an address. In practice the data for loads and stores may be read from or written to one or more caches between the processor and a main memory, e.g., a DRAM device. For simplicity, the examples in this specification omit the details of intermediate caches and thus, writing to or reading from memory encompasses writing to or reading from one or more intermediate caches.

In the illustrated example, the load instruction 104 is reading data from the same address (R4+4) as the store instruction 102. The execution window also includes an add instruction 106 that can only execute after the load instruction 104 has been executed.

Therefore, a CPU can use a STLF procedure to execute the add instruction 106 without waiting for the store instruction 102 and the load instruction 104 to complete. To so, the CPU can store the data in register R1 in an internal store queue. Then when the load instruction 104 is executed, the CPU can compare the address of the load instruction 104 to addresses in the store queue. If there is a match, the CPU can forward the data from the store queue into the register R2 without waiting for the store instruction 102 to complete. The add instruction 106 can then be executed using the forwarded data stored in register R2.

Without STLF, the CPU writes the data into the memory, e.g., using the store instruction 102, reads the data from the memory after the data is written, e.g., using the load instruction, and executes the add instruction. Waiting until the data is written to the memory before executing the rest of the instructions can reduce performance of the CPU by approximately 5-10%. However, the STLF stages illustrated in FIG. 1A can be implemented to forward the data from the store instruction to the load instruction so that the CPU does not have to wait until the data is written to the memory.

FIG. 1B is a diagram of the execution stages 110 of an STLF process on the instructions 102, 104, 106 included in the execution window 102. In the illustrated example, the STLF process executes in five stages, but in other implementations more or fewer stages can be executed. In a first, address generation (AGEN) stage 112, the CPU reads the load instruction 104 and determines an address (VA) that corresponds to the load instruction 104.

In a search stage 114, the CPU searches a store queue. In one example, the CPU can include, e.g., a content-addressable memory (CAM) structure which holds in-flight memory instructions and supports simultaneous searches. The CPU searches the store queue to determine whether data for in-flight store instructions are present. In the illustrated example, the store queue includes store instructions that correspond to the load instruction 104 because the store instruction 102 is present in the execution window before the load instruction 104. When large store queues are present, this can take multiple, e.g., many, cycles.

In a third stage 116, the CPU reads data from the store queue after finding the location of the proper store instructions. For example, the CPU can read the data that is being written into the memory by the store instruction. Because the CPU can read this data from the store queue, the CPU does not have to wait for the data to be written into the memory to use the data, e.g., in a load instruction.

In a fourth stage 118, the CPU aligns the data and performs a bypass stage to provide the data obtained from the store queue to one or more consumer instructions that are waiting on that data. For example, the CPU can execute the load instruction 104 and the add instruction 106 after reading the corresponding data from the store queue.

In a fifth stage 120, the CPU writes the data back into the designated memory address, e.g., a destination register. Writing data back includes writing the read data to the designated memory address, e.g., the destination register. In some implementations, a CPU can bypass the read data to dependent instructions, e.g., the ADD instructions, before the designated memory address is updated, e.g., during a bypass stage.

As discussed above, completing the STLF process efficiently becomes difficult for large store queues. For example, completing the search stage 114 takes longer because a larger store queue has more indexes to search. Even with efficient searching algorithms, searching a large store queue of, e.g., 100 entries, can take longer than one cycle. This results in a longer latency for the end user.

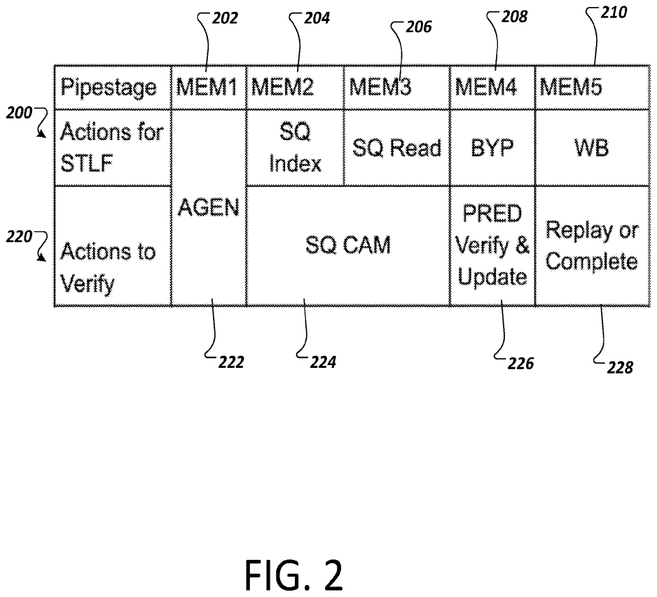

FIG. 2 illustrates a diagram of the execution stages 200 of a predictive STLF process. Using a predictive STLF can avoid consuming multiple cycles to search a large store queue. The example process can instead provide a predictable and bounded number of cycles for determining a store queue index. The illustrated predictive STLF process executes two separate processes in parallel over five stages, similar to the STLF process of FIG. 1. However, the predictive STLF process can achieve efficient results even with store queues of over 100 entries. In some implementations, more or fewer stages can be executed.

In a first stage 202, the CPU reads the load instruction and determines a virtual address that corresponds to the load instruction. For example, the CPU can read the load instruction because the load instruction is present in the execution window. Instead of executing the load instruction, which would require waiting for the store instruction to write the data into the memory address before reading the memory address, the CPU executes the rest of the stages of the STLF process.

In a second stage 204, the CPU performs a predictive process to generate a predicted store queue index of the store instruction that contains the given address. The index can be representative of the position of the store instruction within the store queue. For example, the CPU can use a prediction table that contains addresses and store queue indexes to point the CPU to the location of the proper store instruction in the store queue. An exemplary prediction table is discussed further below. Because the prediction table is much smaller than the store queue, the store queue index prediction can easily be achieved in one cycle.

In a third stage 206, the CPU reads data from the store queue after generating the predicted location of the store instruction. For example, the CPU can read the data that is being written into the memory by the store instruction. Because the CPU can read this data from the store queue, the CPU does not have to wait for the data to be written into the memory to use the data, e.g., in a load instruction.

In a fourth stage 208, the CPU aligns the data and bypasses the data, e.g., to the user and/or necessary instruction. For example, the CPU can execute the load instruction 104 and the add instruction 106 after reading the corresponding data from the store queue. In a fifth stage 120, the CPU writes the data back into the designated memory address, e.g., a destination register.

The predictive STLF process includes a parallel verification process 220 that runs simultaneously with the predictive STLF process. The parallel verification process 220 verifies whether the predictive STLF process correctly predicted the index of the store instructions in the store queue, e.g., during the second stage 204. In a first stage 222, the CPU reads the load instruction and determines a virtual address that corresponds to the load instruction. For example, the CPU can read the load instruction because the load instruction is present in the execution window.

In a second stage 224, the CPU searches the store queue to determine whether store instructions are present for the given virtual address. In the illustrated example, the store queue includes store instructions that correspond to the load instruction because the store instruction is present in the execution window before the load instruction. During the parallel verification process 220, the search can take two cycles because the predictive STLF process is executing simultaneously. This reduces the latency that affects the end user, e.g., during the STLF process of FIG. 1.

In a third stage 226, the CPU compares the result of the search with the predicted store queue index. If the index of the search results are the same as the predicted store queue index, then the parallel verification process 220 succeeds and determines that the predictive STLF process is a success. If the index of the search results are different than the predicted store queue index, then the parallel verification process determines that the predictive STLF process fails. When the predictive STLF process fails, the CPU updates the predicted store queue index so that it is the same as the index of the search results. The CPU can also update other parameters of the predictive STLF process, e.g., parameters within a prediction table. The CPU then executes the fourth stage 228 when the parallel verification process 220 determines that the predictive STLF process fails.

In the fourth stage 228, the CPU replays the load function according to the search results determined in the third stage 226. For example, if only a few instructions were executed according to the incorrect predictive results, then those instructions can be executed again with the correct data determined by the parallel verification process 220. Other instructions that were unrelated to the incorrect predictive results can continue to execute uninhibited. In some implementations, if many instructions were executed according to the incorrect predictive results, the CPU can execute a lightweight replay, in which the instructions executed after the incorrect predictive results can be execute again correctly. This can be helpful, e.g., if the incorrect predictive results propagated into a large number of other instructions.

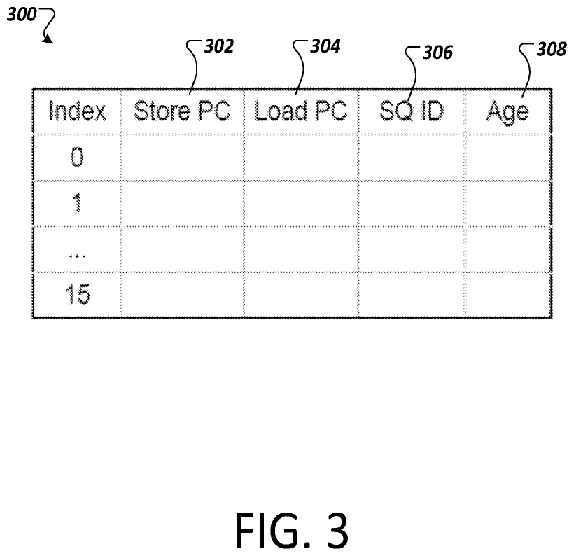

FIG. 3 illustrates an exemplary table 300 that can be used for a predictive STLF process. For example, the table 300 can be used as a prediction table for the predictive STLF process 200 of FIG. 2. The table 300 can be sized to hold a desired number of indices. For example, in the illustrated embodiment, the table 300 can hold 16 store queue indices. Saving 16 store queues at a time can allow the predictive STLF process to efficiently forward data given a large store queue, e.g., with 100 entries. The size of the table 300 can be increased or decreased to allow the predictive STLF process to efficiently forward data given differently sized store queues. For example, a store queue with over 200 entries can use a larger table. For each index, the table 300 can hold a store PC value 302, a load PC value 304, a store queue index 306, and an age value 308.

When a CPU begins processing instructions from an execution window, the CPU will come across store instructions, as described above. When the CPU comes across a store instruction, it will populate the table 300 according to the store instruction.

Similarly, when the CPU comes across a load instruction, it will use the table 300 to perform STLF, as described above, and will populate the table 300 according to the load instruction. For example, the CPU can populate the table with the store PC value 302, the load PC value 304, the store queue index 306, and the age value 308. The age value 308 is representative of the order in which store instruction values are held in the table 300. The age value can be used for determining which entry to replace when a new prediction value needs to be inserted into the table. The CPU can then begin executing the store instruction.

When the CPU comes across a store instruction, it will search the table 300 for a corresponding store PC value 302. For example, the store PC value 302 can be representative of a virtual address received from a store instruction. If the table 300 includes the corresponding store PC value, the CPU will update the store queue index 306 to correspond to the correct store PC value. For example, the CPU will update the store queue index 306 to contain a value that represents the position of the store instruction within the store queue. The CPU will also update the age value 308 to represent that the values are newly stored. If the table 300 does not include the store PC value 302, then the CPU will update the table to include the store PC value 302. The CPU will then update the store queue index 306 to correspond to the correct store PC value. The CPU will also update the age value 308 to represent that the values are newly stored.

When the CPU comes across a load instruction, it will search the table 300 for a corresponding load PC value 304. For example, the load PC value 304 can be representative of a virtual address received from a load instruction. If the table 300 includes the corresponding load PC value, the CPU will use the corresponding store queue index 306 to predict where in the store queue the load PC value should be forwarded from. This information can be carried to the load store unit (LSU) where it is used to execute the load instruction. The CPU will also update the age value 308 to represent that these values are newly stored. If the table 300 does not include the corresponding load PC value, then the CPU will determine the store queue index, e.g., via the parallel verification process. The CPU will update the table 300 with the store queue index 306. The CPU will also update the age value 308 to represent that these values are newly stored. If the parallel verification process does not identify a store instruction that the load instruction should forward from, then the load instruction can complete execution with data read from the cache.

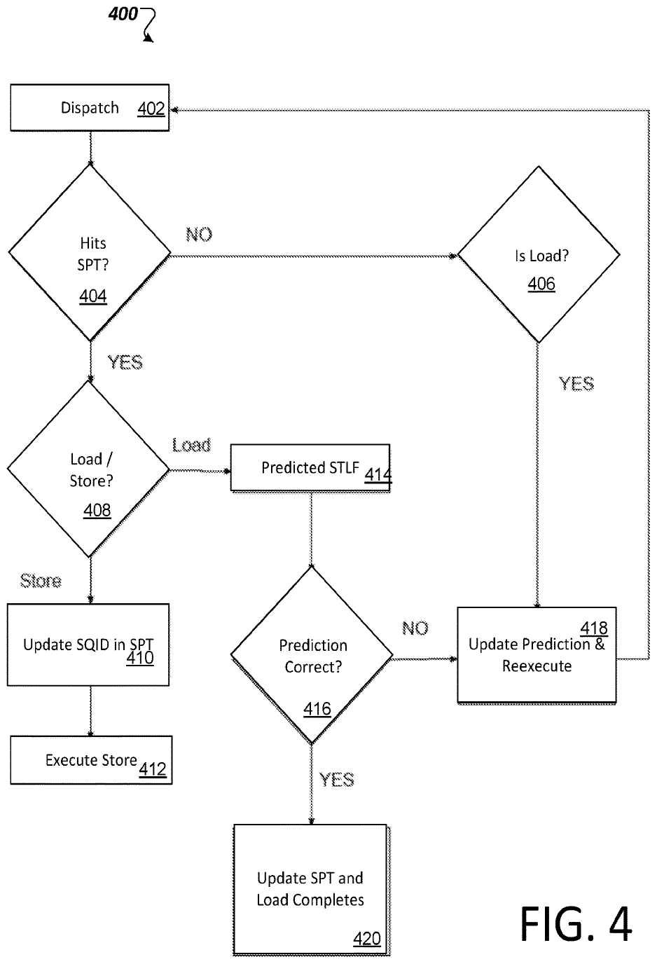

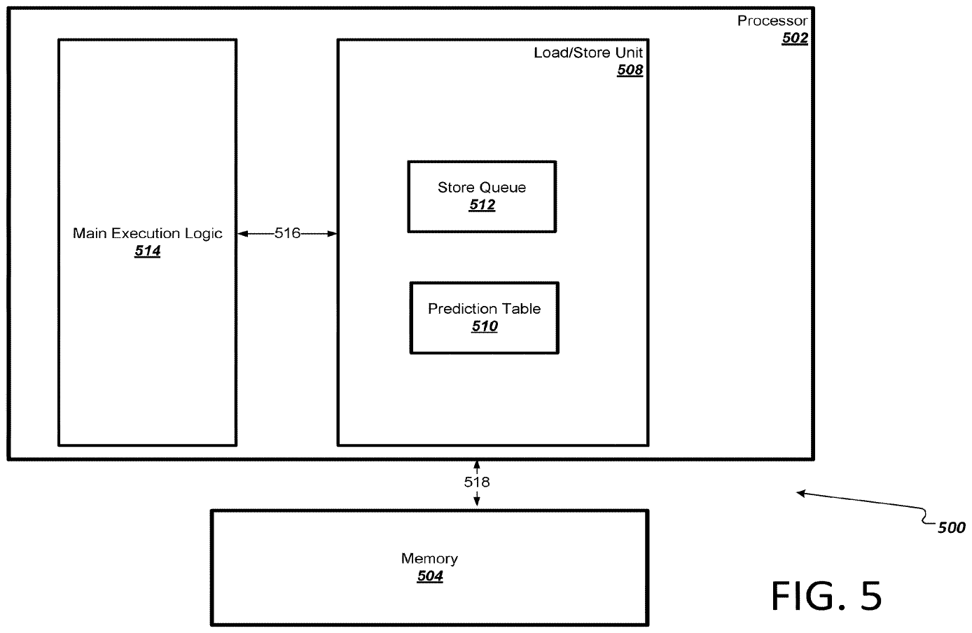

FIG. 4 is a flowchart illustrating an exemplary method of a predictive STLF process 400. The example process can be performed by one or more processors. The example process will be described as being performed by, e.g., processor 502 of FIG. 5, configured in accordance with this specification. The processor 502 will be further described below.

The processor dispatches an instruction, e.g., from an execution window (402). For example, the processor can read an instruction from an execution window and dispatch the instruction according to the contents of the instruction. If the instruction is a load instruction or a store instruction, the processor can dispatch the instruction according to the method 400.

The processor determines whether the instruction matches a value stored in a store queue prediction table (SPT) (404). For example, the prediction table 300 of FIG. 3 includes a store PC value 302, a load PC value 304, a store queue index 306, and an age value 308. If the contents of the instruction match the store PC value or the load PC value, then the instruction matches a value stored in the prediction table. The processor can also determine when the contents of the instruction do not match the values stored in the prediction table.

If the instruction does not match a value stored in the prediction table, the processor determines whether the instruction is a load (406). If the instruction is a load, the processor continues to update the prediction table and re-execute instructions (418), as will be discussed further below.

If the instruction matches a value stored in the prediction table, then the processor can determine whether the instruction is a load instruction or whether the instruction is a store instruction (408).

If the processor determines that the instruction is a store instruction, then the processor can update the store queue index in the prediction table (410). For example, the processor can update the store queue index to contain a value that represents the position of the store instruction within the store queue. The processor can also update the age value in the prediction table to represent that the values are newly stored.

The processor then executes the store instruction (412). For example, the processor can forward the store instruction to the load store unit (LSU) to execute the store instruction. The contents of the store instruction are stored in the virtual address in the memory.

If the processor determines that the instruction is a load instruction, then the processor can execute a predictive STLF process (414). For example, the processor can predict the index of the store instruction that contains the virtual address given in the load instruction. For example, the processor can use the prediction table that contains addresses and store queue indexes to point the processor to the location of the proper store instruction in the store queue. The processor can read data from the store queue after finding the location of the proper store instructions. For example, the processor can read the data that is being written into the memory by the store instruction. The processor can align the data and bypasses the data, e.g., to the user and/or necessary instruction.

The processor can also execute a parallel verification process that runs simultaneously with the predictive STLF process (416). The parallel verification process verifies whether the predictive STLF process correctly predicted the index of the store instructions in the store queue. The processor searches the store queue to determine whether store instructions are present for the virtual address given by the load instruction. The processor compares the result of the search with the predicted store queue index. If the index of the search results are the same as the predicted store queue index, then the parallel verification process succeeds and determines that the predictive STLF process is a success. If the index of the search results are different than the predicted store queue index, then the parallel verification process determines that the predictive STLF process fails.

If the prediction is incorrect, e.g., the predictive STLF process fails, then the processor updates the prediction table and re-executes instructions (418). For example, the processor replays the load function according to the search results determined by the parallel verification process. For example, if only a few instructions were executed according to the incorrect predictive results, then those instructions can be executed again with the correct data determined by the parallel verification process. Other instructions that were unrelated to the incorrect predictive results can continue to execute uninhibited. In some implementations, if many instructions were executed according to the incorrect predictive results, the CPU can flush all of the instructions executed after the incorrect predictive results and can execute all of the instructions again. This can be helpful, e.g., if the incorrect predictive results propagated into a large number of other instructions. Once the instructions are re-executed using the correct data, the processor can move onto the next instruction in the execution window.

If the prediction is correct, e.g., the predictive STLF process succeeds, then the processor updates the prediction table and executes the load instruction (420). For example, the load instruction and the store queue index can be forwarded to the load store unit (LSU) where they are used to execute the load instruction. The processor can also update the age value in the prediction table to represent that these values are newly stored.

FIG. 5 is an example computational environment 500 that can perform a predictive STLF process. The environment includes a processor 502 and a memory 504, e.g., a cache, random-access memory (RAM), read-only memory (ROM), etc. The processor 502 can execute a predictive STLF process, as described above. A load store unit (LSU) 506 contains a predictive STLF Module 508 that includes a prediction table 510 and a store queue 512. The prediction table 510 can be similar to, e.g., the prediction table 300 of FIG. 3. The store queue 512 can include a content-addressable memory (CAM) structure which holds in-flight memory instructions and supports simultaneous searches. The LSU 506 communicates with a main execution logic 514 to receive and send data. For example, communications 516 between the LSU and the main execution logic can include store instructions, load instructions, stored values, etc. The processor 502 communicates with the memory 504 to receive and send data. For example, the communications 518 between the processor and the memory can include memory addresses, stored values, etc.

Embodiments of the subject matter and the functional operations described in this specification can be implemented in digital electronic circuitry in computer hardware, including the structures disclosed in this specification and their structural equivalents, or in combinations of one or more of them. The processes and logic flows can also be performed by special purpose logic circuitry, e.g., an FPGA or an ASIC, or by a combination of special purpose logic circuitry and one or more programmed computers.

In addition to the embodiments described above, the following embodiments are also innovative:

Embodiment 1 is a method for performing predictive store-to-load forwarding on a processor, the method comprising:
receiving a load instruction;
performing a predictive store-to-load forwarding process including:
   obtaining, from a prediction table, a predicted store queue id based on an address of the load instruction,
   looking up a value from a store queue based on the store queue id while performing a parallel verification process for the predicted store queue id;
determining that the parallel verification process succeeded; and
in response, reading the value for the load instruction from the store queue.

Embodiment 2 is the method of claim 1, further comprising receiving a store instruction, and populating the prediction table based on the store instruction.

Embodiment 3 is the method of any one of embodiments 1-2, further comprising reloading a number of load instructions when the verification process fails.

Embodiment 4 is the method of any one of embodiments 1-3, wherein the parallel verification process comprises searching the store queue for the address of the load instruction.

Embodiment 5 is the method of any one of embodiments 1-4, wherein the parallel verification process comprises updating the prediction table upon a successful prediction.

Embodiment 6 is the method of embodiment 5, wherein updating the prediction table comprises updating a value related to the age of the load instruction.

Embodiment 7 is the method of any one of embodiments 1-6, wherein the parallel verification process comprises updating the prediction table upon an unsuccessful prediction.

Embodiment 8 is the method of embodiment 7, wherein updating the prediction table comprises updating a value related to the store queue id.

Embodiment 9 is the method of any one of embodiments 1-8, further comprising receiving a store instruction.

Embodiment 10 is the method of embodiment 9, further comprising updating the predicted store queue id based on the received store instruction.

Embodiment 11 is the method of embodiment 9, further comprising executing the store instruction after updating the predicted store queue id.

Embodiment 12 is a system for performing predictive store-to-load forwarding, the system comprising:
a memory configured to store instructions; and
a processor to execute the instructions to perform operations comprising:
   receiving a load instruction;
   performing a predictive store-to-load forwarding process including:
      obtaining, from a prediction table, a predicted store queue id based on an address of the load instruction,
      looking up a value from a store queue based on the store queue id while performing a parallel verification process for the predicted store queue id;
determining that the parallel verification process succeeded; and
in response, reading the value for the load instruction from the store queue.

Embodiment 13 is the system of embodiment 12, further comprising receiving a store instruction, and populating the prediction table based on the store instruction

Embodiment 14 is the system of any one of embodiments 12-13, further comprising reloading a number of load instructions when the verification process fails.

Embodiment 15 is the system of any one of embodiments 12-14, wherein the parallel verification process comprises searching the store queue for the address of the load instruction.

Embodiment 16 is the system of any one of embodiments 12-15, wherein the parallel verification process comprises updating the prediction table upon a successful prediction.

Embodiment 17 is the system of embodiment 16, wherein updating the prediction table comprises updating a value related to the age of the load instruction.

Embodiment 18 is the system of any one of embodiments 12-17, wherein the parallel verification process comprises updating the prediction table upon an unsuccessful prediction.

Embodiment 19 is the system of embodiment 18, wherein updating the prediction table comprises updating a value related to the store queue id.

Embodiment 20 is the system of any one of embodiments 12-19, further comprising receiving a store instruction.

Embodiment 21 is the system of embodiment 20, further comprising updating the predicted store queue id based on the received store instruction.

Embodiment 22 is the system of embodiment 20, further comprising executing the store instruction after updating the predicted store queue id.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain some cases, multitasking and parallel processing may be advantageous.

What is claimed is:

1. A method for performing predictive store-to-load forwarding on a processor, the method comprising:
receiving a load instruction;
performing a predictive store-to-load forwarding process including:
obtaining, from a prediction table, a predicted store queue id based on an address of the load instruction,
looking up a value from a store queue based on the store queue id while performing a parallel verification process for the predicted store queue id;
determining that the parallel verification process succeeded; and
in response, reading the value for the load instruction from the store queue.

2. The method of claim 1, further comprising receiving a store instruction, and populating the prediction table based on the store instruction.

3. The method of claim 1, further comprising reloading a number of load instructions when the verification process fails.

4. The method of claim 1, wherein the parallel verification process comprises searching the store queue for the address of the load instruction.

5. The method of claim 1, wherein the parallel verification process comprises updating the prediction table upon a successful prediction.

6. The method of claim 5, wherein updating the prediction table comprises updating a value related to the age of the load instruction.

7. The method of claim 1, wherein the parallel verification process comprises updating the prediction table upon an unsuccessful prediction.

8. The method of claim 7, wherein updating the prediction table comprises updating a value related to the store queue id.

9. The method of claim 1, further comprising receiving a store instruction.

10. The method of claim 9, further comprising updating the predicted store queue id based on the received store instruction.

11. The method of claim 9, further comprising executing the store instruction after updating the predicted store queue id.

12. A system for performing predictive store-to-load forwarding, the system comprising:
a memory configured to store instructions; and
a processor to execute the instructions to perform operations comprising:
receiving a load instruction;
performing a predictive store-to-load forwarding process including:
obtaining, from a prediction table, a predicted store queue id based on an address of the load instruction,
looking up a value from a store queue based on the store queue id while performing a parallel verification process for the predicted store queue id;
determining that the parallel verification process succeeded; and
in response, reading the value for the load instruction from the store queue.

13. The system of claim 12, further comprising receiving a store instruction, and populating the prediction table based on the store instruction.

14. The system of claim 12, further comprising reloading a number of load instructions when the verification process fails.

15. The system of claim 12, wherein the parallel verification process comprises searching the store queue for the address of the load instruction.

16. The system of claim 12, wherein the parallel verification process comprises updating the prediction table upon a successful prediction.

17. The system of claim 16, wherein updating the prediction table comprises updating a value related to the age of the load instruction.

18. The system of claim 12, wherein the parallel verification process comprises updating the prediction table upon an unsuccessful prediction.

19. The system of claim 18, wherein updating the prediction table comprises updating a value related to the store queue id.

20. The system of claim 12, further comprising receiving a store instruction.

21. The system of claim 20, further comprising updating the predicted store queue id based on the received store instruction.

22. The system of claim 20, further comprising executing the store instruction after updating the predicted store queue id.
